(19) United States
(12) Patent Application Publication
(10) Pub. No.: US 2011/0190054 A1
(43) Pub. Date: Aug. 4, 2011

(54) GAME DEVICE, GAME DEVICE CONTROL METHOD, PROGRAM, AND INFORMATION STORAGE MEDIUM

(75) Inventor: Takeshi Yamaguchi, Tokyo (JP)

(73) Assignee: KONAMI DIGITAL ENTERTAINMENT CO., LTD., Minato-ku, Tokyo (JP)

(21) Appl. No.: 13/122,192

(22) PCT Filed: Jun. 30, 2009
(86) PCT No.: PCT/JP2009/062005

§ 371 Date: Apr. 1, 2011

(30) Foreign Application Priority Data
Oct. 2, 2008 (JP) 2008-257881

(51) Int. Cl. A63F 13/00

(52) U.S. Cl. 463/31

(57) ABSTRACT

To provide a game device capable of making it relatively easier for a player to recognize an image indicating the next operation time. A first display control unit shows a first image (42Ra) for indicating a first operation time to a player and a second image (42Rb) for indicating a second operation time after the first operation time to a player in different positions in a game screen image (40). A second display control unit shows in the game screen image (40) a third image (46R) for indicating to a player a positional relationship between the display position of the first image (42Ra) and the display position of the second image (42Rb).

### TECHNICAL FIELD

The present invention relates to a game device, a game device control method, a program, and an information storage medium.

### BACKGROUND ART

There have been known game devices that each show on a game screen a guide image for indicating to a player an operation time for a player to perform an operation. For example, there have been known game devices that each show on a game screen a guide image for indicating to a player an operation time for a player to perform a step operation.

### PRIOR ART DOCUMENT

### Patent Document

Patent Document 1: JP 2001-246154 A

### DISCLOSURE OF THE INVENTION

### Problems to be Solved by the Invention

In the above described game devices, a plurality of guide images may be shown in different positions. For example, in a game device having a mat or a touch panel for receiving a press operation by a player, a guide image may be shown in a position on the game screen corresponding to a position to be pressed by a player so that the guide image serves to indicate a position on the mat or the touch panel to be pressed by a player at an operation time.

In such a case, as a plurality of guide images are shown in different positions, rather than in one predetermined position, a player may not be able to readily realize where a guide image indicating the next operation time is shown. Further, when two or more guide images are shown on a game screen during similar periods, a player may not be able to readily realize which is the guide image that indicates the next operation time.

The present invention has been conceived in view of the above, and aims to provide, e.g., a game device, a game device control method, a program, and an information storage medium for enabling a player to relatively readily recognize a guide image that indicates the next operation time.

### Means for Solving the Problems

In order to solve the above described problems, a game device according to the present invention comprises first display control means for showing a first image for indicating a first operation time to a player and a second image for indicating a second operation time after the first operation time to the player in different positions in a game screen image, and second display control means for showing in the game screen image a third image for indicating to the player a positional relationship between a display position of the first image and a display position of the second image.

Further, a game device control method according to the present invention comprises a first display control step of showing a first image for indicating a first operation time to a player and a second image for indicating a second operation time after the first operation time to the player in different positions in a game screen image, and a second display control step of showing in the game screen image a third image for indicating to the player a positional relationship between a display position of the first image and a display position of the second image.

Further, a program according to the present invention causes a computer, such as a consumer game device (an installation-type game device), a portable game device, a commercial game device, a portable phone, a personal digital assistant (PDA), a personal computer, and so forth to function as first display control means for showing a first image for indicating a first operation time to a player and a second image for indicating a second operation time after the first operation time to the player in different positions in a game screen image, and second display control means for showing in the game screen image a third image for indicating to the player a positional relationship between a display position of the first image and a display position of the second image.

An information storage medium according to the present invention is a computer readable information storage medium that stores the above described program.

According to the present invention, for example, it is possible to arrange such that a player can relatively easily recognize an image indicating the next operation time.

According to one aspect of the present invention, the second display control means may show as the third image in the game screen image an image that moves from a first position corresponding to the display position of the first image to a second position corresponding to the display position of the second image.

According to one aspect of the present invention, an operation required by the player at the first operation time may be an operation related to a first foot that is either a right foot or a left foot. An operation required by the player at the second operation time may be an operation related to a second foot that is the opposite foot to the right foot or the left foot. The first image may include an image representing the first foot. The second display control means may move an image formed by reversing the image representing the first foot from the first position to the second position.

According to one aspect of the present invention, an operation required by the player at the first operation time may be an operation related to a first hand that is either a right hand or a left hand. An operation required by the player at the second operation time may be an operation related to a second hand that is the opposite hand yo the right hand or the left hand. The first image may include an image representing the first hand. The second display control means may move an image formed by reversing the image representing the first hand from the first position to the second position.

### BRIEF DESCRIPTION OF THE DRAWINGS

FIG. 1 is a diagram showing a hardware structure of a game device according to this embodiment;

FIG. 2 is a diagram showing a situation in which a player plays;

FIG. 3 is a diagram explaining a game screen image;

FIG. 4 is a diagram explaining a game screen image;

FIG. 5 is a diagram explaining a right foot image;

FIG. 6 is a diagram explaining a left foot image;

FIG. 7 is a diagram showing one example of a game screen image;

FIG. 8 is a diagram showing one example of a game screen image;

FIG. 9 is a functional block diagram of a game device according to this embodiment;

FIG. 10 is a diagram showing one example of reference operation information;

FIG. 11 is a flowchart of one example of a process carried out in the game device;

FIG. 12 is a flowchart of one example of a process carried out in the game device;

FIG. 13 is a diagram explaining an operation receiving period;

FIG. 14 is a diagram showing one example of a game screen image;

FIG. 15 is a diagram showing one example of a game screen image; and

FIG. 16 is a flowchart of another example of a process carried out in the game device.

### BEST MODE FOR CARRYING OUT THE INVENTION

In the following, one example of an embodiment of the present invention will be described in detail based on the accompanying drawings. A game device according to an embodiment of the present invention may comprise, for example, a consumer game device (an installation-type game device), a portable game device, a portable phone, a personal digital assistant (PDA), a personal computer, or the like. In the following, a case in which a game device according to an embodiment of the present invention is realized using a consumer game device will be described.

### 1. STRUCTURE

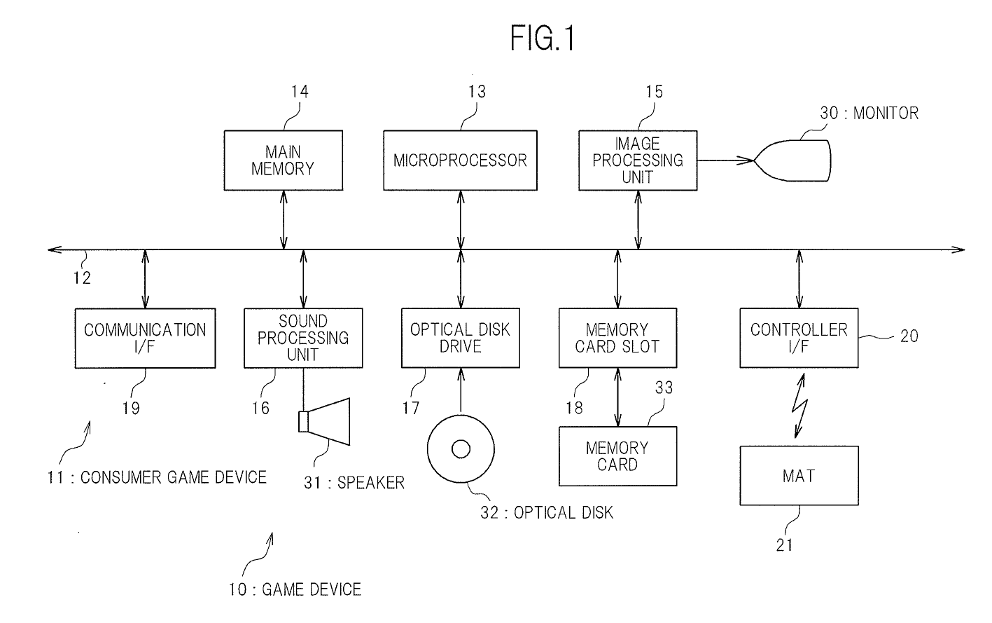

FIG. 1 shows a structure of a game device according to this embodiment. As shown in FIG. 1, a game device 10 according to this embodiment comprises a consumer game device 11, a monitor 30, a speaker 31, an optical disk 32, and a memory card 33. The monitor 30 and the speaker 31 are connected to the consumer game device 11. The optical disk 32 and the memory card 33 are each an information storage medium, and mounted in the consumer game device 11. For example, a home-use television set receiver is used as the monitor 30, and a speaker built-in a home-use television set receiver is used as the speaker 31.

The consumer game device 11 is a publicly known computer game system, and comprises a bus 12, a microprocessor 13, a main memory 14, an image processing unit 15, a sound processing unit 16, an optical disk drive 17, a memory card slot 18, a communication interface (I/F) 19, a controller interface (I/F) 20, and a mat 21. Structural components other than the mat 21 are accommodated in the enclosure of the consumer game device 11.

The bus 12 is used to exchange an address and data between the respective units of the consumer game device 11. The microprocessor 13, the main memory 14, the image processing unit 15, the sound processing unit 16, the optical disk drive 17, the memory card slot 18, the communication interface 19, and the controller interface 20 are connected to one another via the bus 12 for data exchange.

The microprocessor 13 carries out various information processes based on an operating system stored in a ROM (not shown) and a program read from the optical disk 32 or the memory card 33. The main memory 14 includes, e.g., a RAM, in which a program and data read from the optical disk 32 or the memory card 33 are written when necessary. The main memory 14 is used also as a working memory of the microprocessor 13.

The image processing unit 15 includes a VRAM, and renders into the VRAM a game screen image, based on the image data sent from the microprocessor 13. The image processing unit 15 converts the game screen image into a video signal before outputting to the monitor 30 at a predetermined time. The sound processing unit 16 includes a sound buffer, and outputs via the speaker 31 various sound data (game music, game sound effects, messages, and so forth) having been read from the optical disk 32 into the sound buffer.

The optical disk drive 17 reads a program and data recorded in the optical disk 32. Note that although the optical disk 32 is used here to supply a program and data to the consumer game device 11, any other information storage medium, such as, for example, the memory card 33, may also be used. Further, a program and data may be supplied to the consumer game device 11 via a data communication network, such as the Internet.

The memory card slot 18 is an interface for mounting the memory card 33. The memory card 33 includes a nonvolatile memory (e.g., EEPROM or the like), and stores various game data, such as, for example, saved data. The communication interface 19 is an interface for communication connection to a data communication network, such as the Internet.

The controller interface 20 is an interface for wireless connection of the mat 21. An interface according to, for example, the Bluetooth (registered trademark) interface standard may be used as the controller interface 20. Note that the controller interface 20 may be an interface for wired connection of the mat 21, instead.

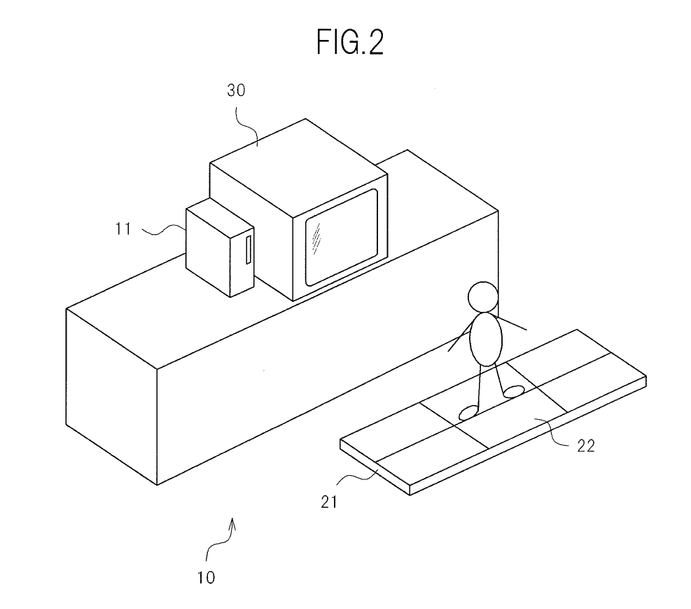

The mat 21 is a mat-type controller, and receives a press operation (a step operation) by a player. FIG. 2 is a diagram explaining the mat 21, showing a situation in which a player plays a game. As shown in FIG. 2, the mat 21 has a substantially rectangular surface 22, and is placed on the floor in front of the monitor 30. A player standing on the mat 21 plays a game. The mat 21 incorporates a plurality of pressure sensors arranged in a matrix. Each pressure sensor detects a pressure generated by, for example, being stepped on by a player, and outputs a numerical value (e.g., a numerical value at e.g., 256 levels) that indicates a result of detection. The numerical values output from the respective pressure sensors are supplied via the controller interface 20 to the microprocessor 13, which then calculates the position stepped on by the player, based on the detection results supplied from the respective pressure sensors.

### 2. GAME

The game device 10 carries out a game in which, for example, a player performs a step operation on the mat 21, following an instruction shown on the game screen.

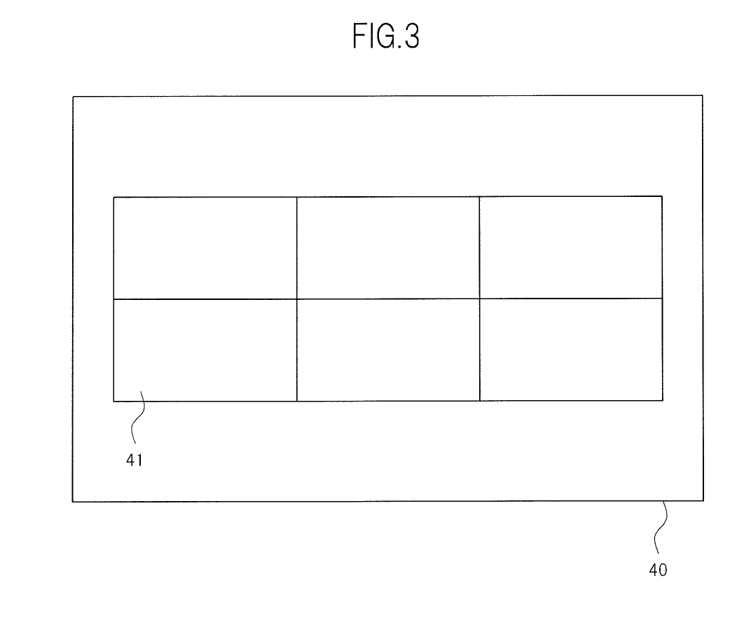

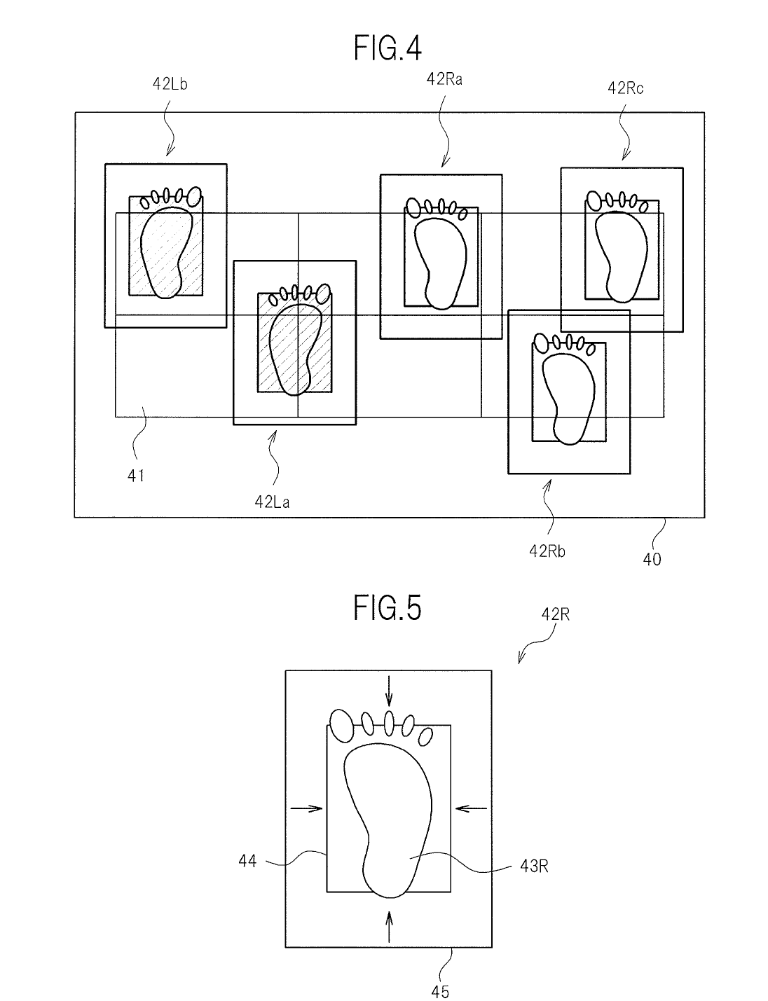

FIGS. 3 and 4 are diagrams explaining a game screen image. In particular, FIG. 3 shows one example of a game screen image initially shown after a game starts. As shown in FIG. 3, a mat image 41 is shown in a game screen image 40. The mat image 41 is an image representing the surface 22 of the mat 21. With the game started and a time (an operation time) for a player to perform a step operation with their right or left foot approaching, an image for indicating an operation time to a player is shown. FIG. 4 shows one example of such a game screen image 40. In particular, right foot images 42Ra, 42Rb, 42Rc and left foot images 42La, 42Lb are shown in the game screen image 40 shown in FIG. 4. The right foot images 42Ra, 42Rb, 42Rc correspond to images related to a step operation with a right foot, specifically, serving to indicate an operation time for a player to perform a step operation with their right foot and a position on the mat 21 to be stepped on by a player with their right foot at the operation time. Similarly, the left foot images 42La, 42Lb correspond to images related to a step operation with a left foot, specifically, serving to indicate an operation time for a player to perform a step operation with their left foot and a position on the mat 21 to be stepped on by a player with their left foot at the operation time.

FIG. 5 is a diagram explaining in detail the right foot image 42R (42Ra, 42Rb, 42Rc). As shown in FIG. 5, the right foot image 42R includes a right foot main image 43R, a reference image 44, and a time indicating image 45.

Specifically, the right foot main image 43R is an image representing a footprint of a right foot, and is shown in a position in the game screen image 40 corresponding to a position on the mat 21 to be stepped on by a player with their right foot, thereby serving to indicate a position on the mat 21 to be stepped on by a player with their right foot. Referring to the right foot main image 43R, a player can know where to step with their right foot on the mat 21.

The reference image 44 is a substantially rectangular image having a predetermined size. The time indicating image 45 has an analogous relationship to the reference image 44 so that the reference image 44 and the time indicating image 45 are shown with the midpoints thereof matched. The time indicating image 45 is initially larger in size than the reference image 44, and as an operation time approaches, becomes gradually smaller in the directions indicated by the arrows shown in FIG. 5 to be equal in size to and thus coincide with the reference image 44 at the operation time. That is, the reference image 44 and the time indicating image 45 serve to indicate an operation time to a player, as described above, so that the player can know a time at which to perform a step operation with their right foot with reference to the reference image 44 and the time indicating image 45. Note that although the reference image 44 and the time indicating image 45 are rectangular in this embodiment, the reference image 44 and the time indicating image 45 may be in any other shape (e.g., an oval shape) other than a rectangle.

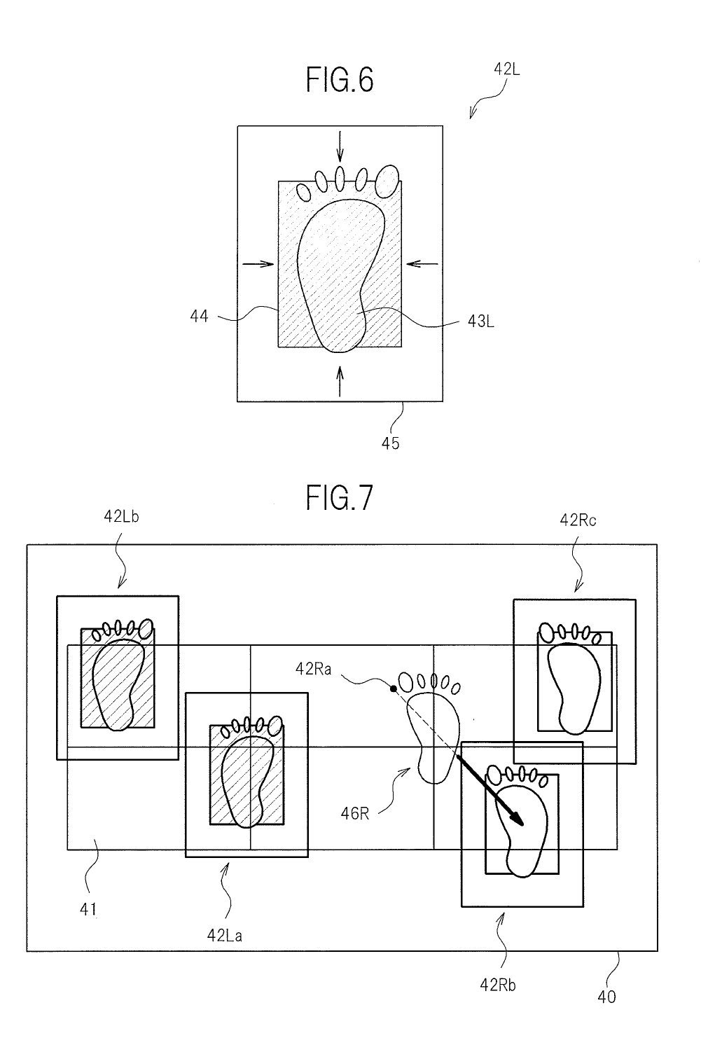

FIG. 6 is a diagram explaining in detail the left foot image 42L (42La, 42Lb). As shown in FIG. 6, the left foot image 42L includes a left foot main image 43L, a reference image 44, and a time indicating image 45. The reference image 44 and the time indicating image 45 are similar to the reference image 44 and the time indicating image 45, respectively, included in the right foot image 42R.

Specifically, the left foot main image 43L is an image representing a footprint of a left foot, and is shown in a position in the game screen image 40 corresponding to a position on the mat 21 to be stepped on by a player with their left foot, thereby serving to indicate a position on the mat 21 to be stepped on by a player with their left foot. Referring to the left foot main image 43L, a player can know where to step with their left foot on the mat 21.

Note that the right foot image 42R and the left foot image 42L are shown in different colors so that the difference in color enables a player to distinguish between the right foot image 42R and the left foot image 42L at a glance.

In the game device 10, the right foot image 42R and left foot image 42L are shown in display positions corresponding to respective positions to be stepped on by a player, thereby serving to indicate a position to be stepped on by a player with their right or left foot. Therefore, display positions of the right foot image 42R and the left foot image 42L are different from each other. This may resultantly make it difficult for a player to realize where the right foot image 42R indicating the next right foot operation time is shown and where the left foot image 42L indicating the next left foot operation time is shown.

Further, in the game device 10, as a plurality of right foot images 42R may be shown in the game screen image 40 during similar periods, as shown in FIG. 4, when an operation time repeatedly arrives with a shorter interval, a player may not be able to readily realize which is the right foot image 42R that indicates the next right foot operation time. Similarly, in the game device 10, as a plurality of left foot images 42L may be shown during similar periods, a player may not be able to readily realize which is the left foot image 42L that indicates the next left foot operation time.

In the following, a technique for making it relatively easier for a player to recognize the right foot image 42R or the left foot image 42L that indicates the next operation time will be described. In the following, it is assumed that operation times arrive in the following order. That is, in the following order, a right foot operation time and a left foot operation time arrive alternately.

(1) right foot image 42Ra
(2) left foot image 42La
(3) right foot image 42Rb
(4) left foot image 42Lb
(5) right foot image 42Rc

FIG. 7 shows one example of the game screen image 40 shown after the right foot operation time indicated by the right foot image 42Ra has passed. As shown in FIG. 7, after the above-described operation time has passed, the right foot image 42Ra disappears. With the right foot image 42Ra having disappeared, a right foot transition indicating image 46R appears, moving from the display position of the right foot image 42Ra toward that of the right foot image 42Rb that indicates the next right foot operation time. Note that the right foot transition indicating image 46R is an image representing the footprint of a right foot, similar to the right foot main image 43R, and serves to indicate a positional relationship between the right foot image 42Ra and the right foot image 42Rb that indicates the next right foot operation time. That is, at the right foot operation time indicated by the right foot image 42Ra, generally, a player is attending to the right foot image 42Ra in order to perform a step operation with their right foot. In connection with the above, in the game device 10, after the right foot operation time indicated by the right foot image 42Ra has passed, the right foot transition indicating image 46R moves from the display position of the right foot image 42Ra that should be attended to by the player at that time toward the right foot image 42Rb that indicates the next right foot operation time. This makes it easier for a player to recognize the right foot image 42Rb indicating the next right foot operation time.

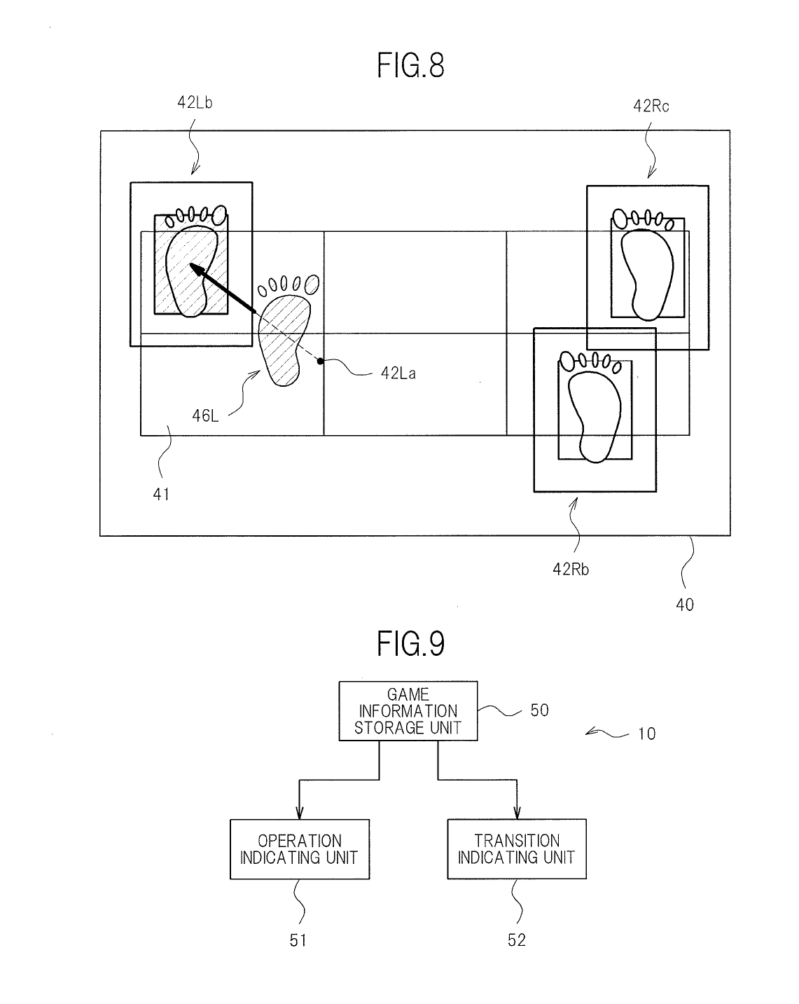

FIG. 8 shows one example of the game screen image 40 shown after a left foot operation time indicated by the left foot image 42La has passed. As shown in FIG. 8, after the above-described operation time has passed, the left foot image 42La disappears. With the left foot image 42La having disappeared, a left foot transition indicating image 46L appears, moving from the display position of the left foot image 42La toward that of the left foot image 42Lb that indicates the next left foot operation time. Note that the left foot transition indicating image 46L is an image representing the footprint of a left foot, similar to the left foot main image 43L, and serves to indicate a positional relationship between the left foot image 42La and the left foot image 42Lb that indicates the next left foot operation time. That is, at the left foot operation time indicated by the left foot image 42La, generally, a player is attending to the left foot image 42La in order to perform a step operation with their left foot. In connection with the above, in the game device 10, after the left foot operation time indicated by the left foot image 42La has passed, the left foot transition indicating image 46L moves from the display position of the left foot image 42La that should be attended to by the player at that time toward the left foot image 42Lb that indicates the next left foot operation time. This makes it easier for a player to recognize the left foot image 42Lb indicating the next left foot operation time.

### 3. FUNCTIONAL BLOCK

FIG. 9 is a functional block diagram mainly showing functions according to the present invention among those realized in the game device 10. As shown in FIG. 9, the game device 10 comprises a game information storage unit 50, an operation indicating unit 51 (first display control means), and a transition indicating unit 52 (second display control means). The game information storage unit 50 is realized using, e.g., the main memory 14 and the optical disk 32. The operation indicating unit 51 and the transition indicating unit 52 are realized mainly using, e.g., the microprocessor 13. The operation indicating unit 51 and the transition indicating unit 52 are realized by the microprocessor 13 executing a program stored in the optical disk 32.

The game information storage unit 50 stores information necessary to carry out a game. For example, reference operation information and display control information are stored in the game information storage unit 50.

The reference operation information includes information related to an operation time for a player to perform an operation and information related to content of an operation to be peformed by a player at the operation time. For example, an operation time is expressed as a time period having elapsed after the start of the game. In a game in which a player performs a game operation according to game music, a bar of the game music is divided into a predetermined number of beats (four or eight beats) so that an operation time is expressed by means of a bar and a beat. In such a game in which a player performs a game operation according to game music, an operation time may be expressed based on the amount of game music data having been reproduced. The content of an operation to be performed by a player refers to, for example, a position to be pressed by a player.

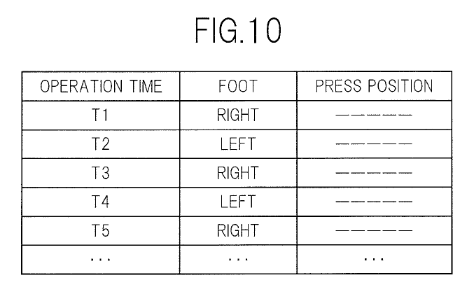

FIG. 10 shows one example of the reference operation information stored in the game information storage unit 50. The reference operation information shown in FIG. 10 describes on which position on the mat 21 a player is to step on with which of their feet at each of the plurality of operation times (T1, T2, T3, T4, T5, and so forth). Specifically, in the reference operation information shown in FIG. 10, a combination of the “foot” and the “press position” corresponds to information describing the content of an operation to be performed by a player.

The display control information is information for showing the right foot image 42R and the left foot image 42L in the game screen image 40, and includes information described below, for example.

(1) Display positions of each right foot image 42R and each left foot image 42L;
(2) Time to start showing each right foot image 42R and each left foot image 42L; and
(3) Time to start size-reduction of each time indicating image 45.

Note that the display positions of the right foot image 42R and the left foot image 42L are determined based on a position on the mat 21 to be stepped on by a player. Further, a time to start showing the right foot image 42R or the left foot image 42L, and a time to start size-reduction of the time indicating image 45 are determined based on a time (an operation time) for a player to perform a step operation with their right or left foot. For example, a time to start showing the right foot image 42R or the left foot image 42L, and a time to start size-reduction of the time indicating image 45 is set to a time that is a little earlier than an operation time. Further, a time to start showing the right foot image 42R or the left foot image 42L is set to a time that is a little earlier than a time at which to start size-reduction of the time indicating image 45.

The game information storage unit 50 additionally stores information describing the current positions of the right foot transition indicating image 46R and of the left foot transition indicating image 46L.

The operation indicating unit 51 shows the right foot image 42R and the left foot image 42L in the game screen image 40. The transition indicating unit 52 shows in the game screen image 40 an image for indicating to a player a positional relationship between the display position of a first image for indicating a first operation time to a player and the display position of a second image for indicating to a player a second operation time after the first operation time.

For example, after the operation time (a first operation time) indicated by the right foot image 42Ra (a first image) has passed in the situation shown in FIG. 4, the transition indicating unit 52 shows the right foot transition indicating image 46R (a third image) in the game screen image 40, the right foot transition indicating image 46R moving from the display position of the right foot image 42Ra toward that of the right foot image 42Rb (a second image) indicating the next right foot operation time (a second operation time) (see FIG. 7).

Further, after the operation time (a first operation time) indicated by the left foot image 42La (a first image) has passed, the transition indicating unit 52 shows the left foot transition indicating image 46L (a third image) in the game screen image 40, the left foot transition indicating image 46L moving from the display position of the left foot image 42La toward that of the left foot image 42Lb (a second image) indicating the next left foot operation time (a second operation time) (see FIG. 8).

### 4. PROCESS

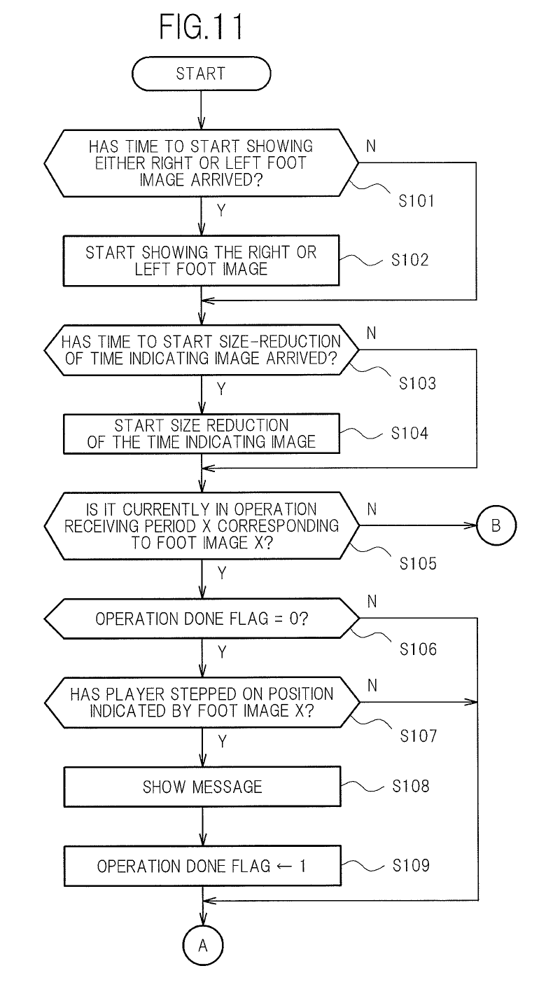

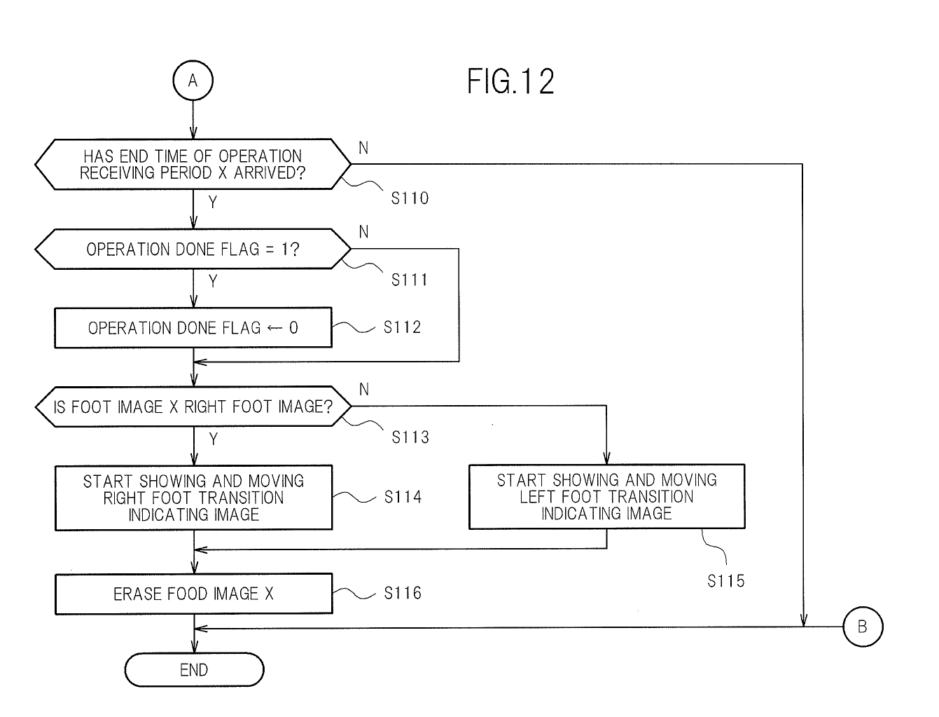

In the following, a process carried by the game device 10 will be described. FIGS. 11 and 12 show a flowchart of a process carried out by the game device 10 every predetermined time period (e.g., 1/60^{th} of a second) in a game. The microprocessor 13 carries out the process shown in FIGS. 11 and 12, according to the program read from the optical disk 32. The operation indicating unit 51 and the transition indicating unit 52 are realized by the microprocessor 13 carrying out the process shown in FIGS. 11 and 12.

As shown in FIG. 11, initially, the microprocessor 13 (the operation indicating unit 51) determines whether or not a time to start showing either of the right foot image 42R or the left foot image 42L has arrived (S101). This determination is made based on the display control information. With such a time to start showing either of the right foot image 42R and the left foot image 42L having arrived, the microprocessor 13 (the operation indicating unit 51) starts showing the right foot image 42R or the left foot image 42L (S102).

Further, the microprocessor 13 (the operation indicating unit 51) determines whether or not a time to start size-reduction of the time indicating image 45 of either the right foot image 42R or the left foot image 42L shown in the game screen image 40 has arrived (S103). This determination is made based on the display control information. With such a time to start size-reduction of the time indicating image 45 having arrived, the microprocessor 13 (the operation indicating unit 51) starts size-reduction of the time indicating image 45 (S104).

Still further, the microprocessor 13 determines whether or not the current moment is included in an operation receiving period (hereinafter referred to as an “operation receiving period X”) corresponding to either of the right foot image 42R or the left foot image 42L (hereinafter referred to as a “foot image X”) (S105). FIG. 13 is a diagram explaining an operation receiving period X, in which the axis (t) corresponds to a time axis. As shown in FIG. 13, the operation receiving period X is, for example, a predetermined period with the operation time X indicated by the foot image X at the half thereof, that is, a time period from a time preceding the operation time X by a predetermined time period (ΔT) to a time subsequent to the operation time X by a predetermined time period (ΔT). The determination at 5105 is made based on the reference operation information.

With the current moment being included in the operation receiving period X corresponding to the foot image X, the microprocessor 13 then determines whether or not an operation done flag indicates 0 (S106). An operation done flag is information indicating whether or not a step operation has been performed in the current operation receiving period X, and takes a value of either 0 or 1. The value “0” indicates a step operation not having being performed in the current operation receiving period X, while the value “1” indicates a step operation having been performed in the current operation receiving period X.

With the operation done flag indicating 0, the microprocessor 13 then determines whether or not a player has stepped on the position indicated by the foot image X (hereinafter referred to as “reference position X”) (S107). For example, initially, the position stepped on by a player is obtained based on the information supplied from the mat 21. Then, whether or not the position stepped on by the player is included in an area within a predetermined distance from the reference position X is determined. With the position stepped on by the player being included in the area, it is then determined that the player has stepped on the reference position X.

With a determination that the player has stepped on the reference position X, the microprocessor 13 then obtains the difference between the operation time X indicated by the foot image X and the time at which the player has actually stepped on the reference position X, and shows a message corresponding to the difference in the game screen image 40 (S108). For example, as shown in FIG. 13, for a relatively small difference, a positive message, such as, for example, “GOOD”, is shown, while for a relatively large difference, a negative message, such as, for example, “BAD”, is shown. Further, the microprocessor 13 updates the operation done flag to 1 (S109).

Further, the microprocessor 13 determines whether or not the end time of the operation receiving period X has arrived (5110). This determination is made based on the reference operation information. With the end time of the operation receiving period X having arrived, the microprocessor 13 then determines whether or not the operation done flag indicates 1 (S111). With the operation done flag indicating 1, the microprocessor 13 updates the operation done flag to 0 (S112). Note that a case in which the operation done flag does not indicate 1 (that is, the operation done flag indicates 0) is a case in which a player has not stepped on the reference position X in the operation receiving period X. In such a case, the microprocessor 13 may show a negative message, such as, for example, “BAD”.

Thereafter, the microprocessor 13 determines whether or not the foot image X is the right foot image 42R (S113). With the foot image X being the right foot image 42R, the microprocessor 13 (the transition indicating unit 52) starts showing and moving the right foot transition indicating image 46R (S114). For example, the right foot transition indicating image 46R is shown in the display position of the right foot main image 43R of the foot image X, and then moved toward the display position of the right foot image 42R immediately after the foot image X. Note that the right foot image 42R immediately after the foot image X refers to a right foot image 42R indicating the right foot operation time that arrives immediately after the right foot operation time indicated by the foot image X.

Meanwhile, if the foot image X is not the right foot image 42R, that is, the foot image X is the left foot image 42L, the microprocessor 13 (the transition indicating unit 52) starts showing and moving the left foot transition indicating image 46L (S115). For example, the left foot transition indicating image 46L is shown in the display position of the left foot main image 43L of the foot image X, and then moved toward the display position of the left foot image 42L immediately after the foot image X. Note that the left foot image 42L immediately after the foot image X refers to a left foot image 42L indicating the left foot operation time that arrives immediately after the left foot operation time indicated by the foot image X.

After S114 or S115, the microprocessor 13 erases the foot image X in the game screen image 40 (S116).

### 5. CONCLUSION

In the above described game device 10, by showing the right foot transition indicating image 46R, it becomes relatively easier for a player to realize which is the right foot image 42R that corresponds to the next operation time at which to perform a step operation with their right foot. For example, after the operation time corresponding to the right foot image 42Ra has passed in the situation shown in FIG. 4, the right foot transition indicating image 46R is shown moving from the right foot image 42Ra toward the right foot image 42Rb (see FIG. 7). With this arrangement, a player can relatively easily realize that the right foot image 42R corresponding to the next operation time at which to perform a step operation with their right foot is the right foot image 42Rb rather than the right foot image 42Rc.

Further, in this game device 10, by showing the left foot transition indicating image 46L, it becomes relatively easier for a player to realize which is the left foot image 42L that corresponds to the next operation time at which to perform a step operation with their left foot. For example, after the operation time corresponding to the left foot image 42La has passed, the left foot transition indicating image 46L is shown moving from the left foot image 42La toward the left foot image 42Lb (see FIG. 8). With this arrangement, a player can relatively easily realize that the left foot image 42L corresponding to the next operation time at which to perform a step operation with their left foot is the left foot image 42Lb.

### 6. MODIFIED EXAMPLES

Note that the present invention is not limited to the above described embodiment.

### 6-1. First Modified Example

The right foot transition indicating image 46R may move toward the right foot main image 43R of the right foot image 42R to be operated next, and arrive at and overlap the right foot main image 43R of the right foot image 42R at the operation time corresponding to the right foot image 42R to be operated next. In this case, with reference to the right foot main image 43R and the right foot transition indicating image 46R, a player can know a time at which to perform a step operation with their right foot. That is, in this case, the right foot main image 43R and the right foot transition indicating image 46R serve to indicate to a player a time at which to perform a step operation with their right foot.

Similarly, the left foot transition indicating image 46L may move toward the left foot main image 43L of the left foot image 42L to be operated next, and arrive at and overlap the left foot main image 43L of the left foot image 42L at the operation time corresponding to the left foot image 42L to be operated next. In this case, with reference to the left foot main image 43L and the left foot transition indicating image 46L, a player can know a time at which to perform a step operation with their left foot. That is, in this case, the left foot main image 43L and the left foot transition indicating image 46L serve to indicate to a player a time at which to perform a step operation with their left foot.

Note that the reference image 44 and the time indicating image 45 can be omitted in the first modified example.

### 6-2. Second Modified Example

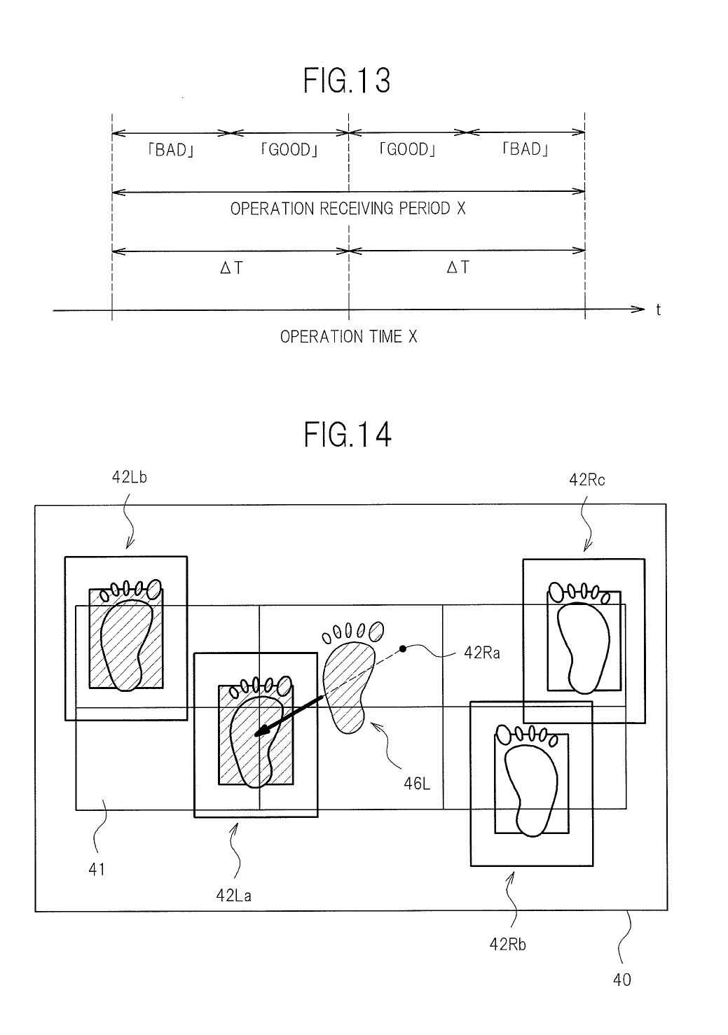

After the operation time corresponding to the right foot image 42Ra has passed in the situation shown in FIG. 4, for example, the transition indicating unit 52 may move the left foot transition indicating image 46L from the display position of the right foot main image 43R of the right foot image 42Ra toward that of the left foot main image 43L of the left foot image 42La corresponding to the next operation time. FIG. 14 shows one example of the game screen image 40 shown in this case. In the game screen image 40 shown in FIG. 14, the left foot transition indicating image 46L moves toward the display position of the left foot main image 43L of the left foot image 42La.

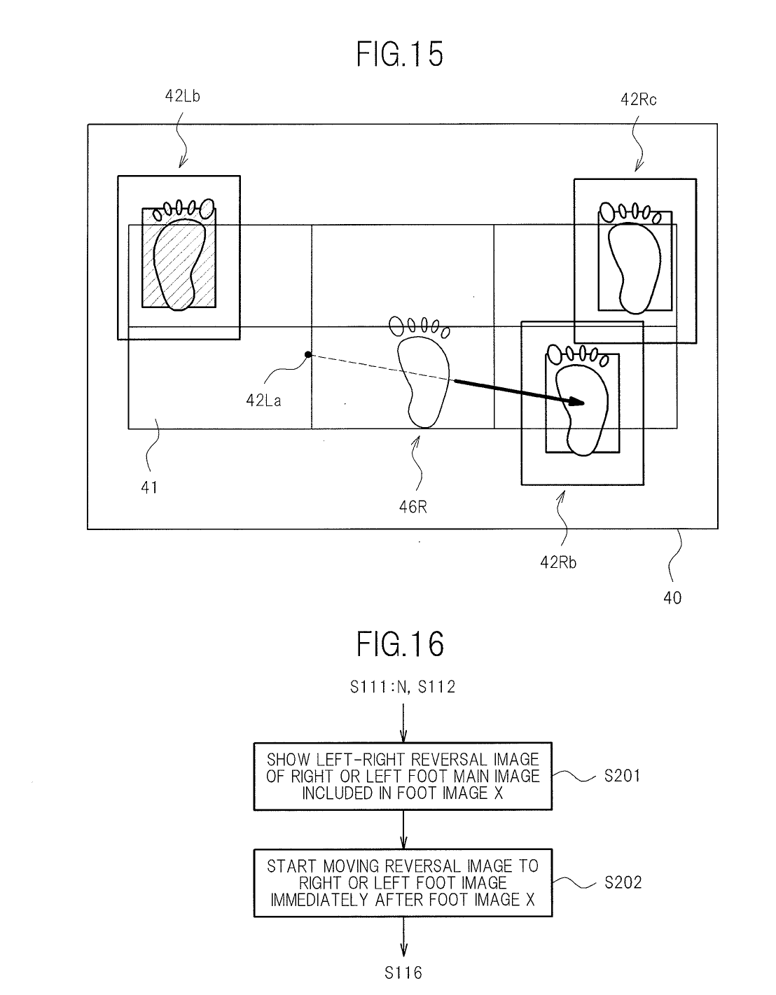

Further, after the operation time corresponding to the left foot image 42La has passed, the transition indicating unit 52 may move the right foot transition indicating image 46R from the display position of the left foot main image 43L of the left foot image 42La toward that of the right foot main image 43R of the right foot image 42Rb corresponding to the next operation time. FIG. 15 shows one example of the game screen image 40 shown in this case. In the game screen image 40 shown in FIG. 15, the right foot transition indicating image 46R moves toward the display position of the right foot main image 43R of the right foot image 42Rb.

In the second modified example, the processes (S201 and 5202) shown in FIG. 16 are carried out instead of the processes at 5114 to 5116 shown in FIG. 12. Specifically, in the process shown in FIG. 16 initially, the microprocessor 13 (the transition indicating unit 52) shows a left-right reversal image of the right foot main image 43R or the left foot main image 43L included in the foot image X in a position based on the display position of the right foot main image 43R or the left foot main image 43L (S201). For example, the reversal image is shown overlapping the right foot main image 43R or the left foot main image 43L. Note that if the foot image X is the right foot image 42R, the reversal image corresponds to the left foot transition indicating image 46L (see FIG. 14), and that if the foot image X is the left foot image 42L, the reversal image corresponds to the right foot transition indicating image 46R (see FIG. 15).

Thereafter, the microprocessor 13 (the transition indicating unit 52) moves the reversal image toward the right foot image 42R or the left foot image 42L immediately after the foot image X (S202). Note that the right foot image 42R or the left foot image 42L immediately after the foot image X refers to the right foot image 42R or the left foot image 42L indicating an operation time that arrives immediately after the operation time indicated by the foot image X.

According to the second modified example, a player can relatively readily realize which is the right foot image 42R or left foot image 42L that indicates the next operation time. Further, in the second modified example, in a case in which a left foot operation time arrives immediately after a right foot operation time, a left-right reversal image of the right foot main image 43R is shown and moved toward the left foot image 42L corresponding to the next left foot operation time. Meanwhile, in a case in which a right foot operation time arrives immediately after a left foot operation time, a left-right reversal image of the left foot main image 43L is shown and moved toward the right foot image 42R corresponding to the next right foot operation time. As described above, in the second modified example, in a case in which an operation time for one foot arrives followed by that for the other foot, a left-right reversal image of the right foot main image 43R or the left foot main image 43L is shown. This makes it relatively easier for a player to realize that an operation with the other foot is required at the next operation time.

Note that the first and second modified examples may be combined. That is, the reversal image may move toward the right foot image 42R or the left foot image 42L immediately after the foot image X, and arrive at and overlap the right foot main image 43R or left foot main image 43L in the right foot image 42R or left foot image 42L at the operation time corresponding to the next right foot image 42R or left foot image 42L. In this case, with reference to the right foot main image 43R or the left foot main image 43L and the reversal image, a player can know a time at which to perform a step operation with their right or left foot. Note that the reference image 44 and the time indicating image 45 can be omitted in this case.

### 6-3. Third Modified Example

The game device 10 may carry out a game in which a player presses the mat 21 with their right or left hand, instead of their right or left foot. In this case, an image representing a right hand may be shown instead of the right foot main image 43R, and an image representing a right hand may be shown as the right foot transition indicating image 46R. Similarly, an image representing a left hand may be shown instead of the left foot main image 43L, and an image representing a left hand may be shown as the left foot transition indicating image 46L. Note that the second and third modified examples may be combined.

### 6-4. Other Modified Examples

For example, the time indicating image 45 may be shown initially smaller in size than the reference image 44, and become gradually larger to be equal in size to and coincide with the reference image 44 at an operation time. That is, an operation time may be indicated to a player in this manner.

Further, for example, a mat that incorporates a relatively small number (e.g., four) of pressure sensors arranged apart from one another (e.g., upper, lower, left, and right sides) may be used instead of the mat 21 that incorporates a relatively large number of pressure sensors arranged in a matrix.

Further, the game device 10 may have a touch panel, instead of the mat 21, for receiving a press operation with, for example, a hand, or the like.

1. A game device, comprising:
first display control means for showing a first image for indicating a first operation time to a player and a second image for indicating a second operation time after the first operation time to the player in different positions in a game screen image; and
second display control means for showing in the game screen image a third image for indicating to the player a positional relationship between a display position of the first image and a display position of the second image.

2. The game device according to claim 1, wherein the second display control means shows as the third image in the game screen image an image moving from a first position corresponding to the display position of the first image to a second position corresponding to the display position of the second image.

3. The game device according to claim 2, wherein
an operation required by the player at the first operation time is an operation related to a first foot that is either a right foot or a left foot,
an operation required by the player at the second operation time is an operation related to a second foot that is an opposite foot to the right foot or the left foot,
the first image includes an image representing the first foot, and
the second display control means moves an image formed by reversing the image representing the first foot from the first position to the second position.

4. The game device according to claim 2, wherein
an operation required by the player at the first operation time is an operation related to a first hand that is either a right hand or a left hand,
an operation required by the player at the second operation time is an operation related to a second hand that is an opposite hand to the right hand or the left hand,
the first image includes an image representing the first hand, and
the second display control means moves an image formed by reversing the image representing the first hand from the first position to the second position.

5. A method of controlling a game device, comprising:
a first display control step of showing a first image for indicating a first operation time to a player and a second image for indicating a second operation time after the first operation time to the player in different positions in a game screen image; and
a second display control step of showing in the game screen image a third image for indicating to the player a positional relationship between a display position of the first image and a display position of the second image.

6. A program for causing a computer to function as
first display control means for showing a first image for indicating a first operation time to a player and a second image for indicating a second operation time after the first operation time to the player in different positions in a game screen image; and
second display control means for showing in the game screen image a third image for indicating to the player a positional relationship between a display position of the first image and a display position of the second image.

7. A computer readable information storage medium storing a program for causing a computer to function as
first display control means for showing a first image for indicating a first operation time to a player and a second image for indicating a second operation time after the first operation time to the player in different positions in a game screen image; and
second display control means for showing in the game screen image a third image for indicating to the player a positional relationship between a display position of the first image and a display position of the second image.
